(19) United States
(12) Patent Application Publication
(10) Pub. No.: US 2024/0219800 A1
(43) Pub. Date: Jul. 4, 2024

(54) ELECTRONIC PAPER DISPLAY DEVICE AND MANUFACTURING METHOD THEREOF

(71) Applicant: E Ink Holdings Inc., HSINCHU (TW)

(72) Inventors: I-Feng CHENG, HSINCHU (TW); Yen-Ze HUANG, HSINCHU (TW); Jen-Shiun HUANG, HSINCHU (TW); Hsin-Tao HUANG, HSINCHU (TW); Po-kai LU, HSINCHU (TW); Ming-Huan YANG, HSINCHU (TW)

(21) Appl. No.: 18/531,716

(22) Filed: Dec. 7, 2023

Related U.S. Application Data
(60) Provisional application No. 63/477,827, filed on Dec. 30, 2022.

(51) Int. Cl. G02F 1/167; G02F 1/16757; G02F 1/16766; G02F 1/1681

(52) U.S. Cl. CPC G02F 1/167; G02F 1/16757; G02F 1/16766; G02F 1/1681

(57) ABSTRACT

An electronic paper display device includes a thin film transistor (TFT) array substrate, a light-transmitting substrate, a top electrode layer, a display medium layer, and a barrier layer. The top surface of the TFT array substrate has a bottom electrode layer. The light-transmitting substrate is located above the TFT array substrate. The top electrode layer is located on the bottom surface of the light-transmitting substrate. The display medium layer is located between the top electrode layer and the bottom electrode layer. The barrier layer is directly formed on at least one of the top surface and the bottom surface of the light-transmitting substrate. The barrier layer is in direct contact with the light-transmitting substrate, and is configured to resist moisture.

### CROSS-REFERENCE TO RELATED APPLICATIONS

This application claims priority to U.S. Provisional Application Ser. No. 63/477,827, filed Dec. 30, 2022 which is herein incorporated by reference.

### BACKGROUND

### Field of Invention

The present disclosure relates to an electronic paper display device and a manufacturing method of the electronic paper display device.

### Description of Related Art

In a market with a wide variety of consumer electronic products, electronic paper display devices have been extensively utilized as display screens. The display medium layer of the electronic paper display device mainly consists of microcapsules having black and white particles. By applying a voltage to the display medium layer, the black and white particles can be driven to move so as to display a black color, a white color, or a gray level. Since the electronic paper display device uses incident light to irradiate the display medium layer to achieve the purpose of display, the electronic paper display device does not need a backlight source, and can save power consumption.

Generally speaking, an electronic paper display device are formed by stacking multi-layer structures, and in order to prevent water vapor from entering, a protective sheet having a moisture barrier layer can be disposed on a front panel laminate (FPL), and an optical clear adhesive (OCA) is used to adhere the protective sheet having the moisture barrier layer to the front panel laminate. Due to the large number of stacked layers of the traditional electronic paper display device, it is difficult to reduce the overall thickness and material cost of the electronic paper display device, and the stacking of multi-layer structures also makes it difficult to improve optical transmittance, which affects the user experience and is not conducive to product competitiveness.

### SUMMARY

One aspect of the present disclosure provides an electronic paper display device.

According to some embodiments of the present disclosure, an electronic paper display device includes a thin film transistor (TFT) array substrate, a light-transmitting substrate, a top electrode layer, a display medium layer, and a barrier layer. A top surface of the TFT array substrate has a bottom electrode layer. The light-transmitting substrate is located above the TFT array substrate. The top electrode layer is located on a bottom surface of the light-transmitting substrate. The display medium layer is located between the top electrode layer and the bottom electrode layer. The barrier layer is directly formed on at least one of a top surface and the bottom surface of the light-transmitting substrate, wherein the barrier layer is in direct contact with the light-transmitting substrate, and is configured to resist moisture.

In some embodiments, the barrier layer is directly formed on the top surface of the light-transmitting substrate, and the top electrode layer is directly formed on the bottom surface of the light-transmitting substrate.

In some embodiments, the bottom surface of the light-transmitting substrate has a functional area extending outward from the display medium layer, and the top electrode layer extends to the functional area.

In some embodiments, a top surface of the barrier layer is exposed.

In some embodiments, the barrier layer is directly formed on the bottom surface of the light-transmitting substrate, and the top electrode layer is directly formed on a bottom surface of the barrier layer, such that the top electrode layer is in direct contact with the barrier layer.

In some embodiments, the bottom surface of the light-transmitting substrate has a functional area extending outward from the display medium layer, and the barrier layer and the top electrode layer extend to the functional area.

In some embodiments, the top surface of the light-transmitting substrate is exposed.

In some embodiments, a sidewall of the light-transmitting substrate, an edge of the barrier layer, and an edge of the top electrode layer are aligned with each other in a vertical direction.

In some embodiments, an edge of the display medium layer is recessed from a sidewall of the light-transmitting substrate so that the light-transmitting substrate has a protruding portion, and the electronic paper display device further includes a sealant located between the protruding portion of the light-transmitting substrate and the TFT array substrate, and the sealant surrounds the display medium layer.

In some embodiments, the sealant is in contact with a bottom surface of the top electrode layer.

In some embodiments, the sealant extends to a lower portion of the sidewall of the light-transmitting substrate, such that an upper portion of the sidewall of the light-transmitting substrate is exposed.

In some embodiments, the display medium layer includes a plurality of microcapsules or a plurality of microcups, and each of the microcapsules or each of the microcups has charged particles with different colors.

According to some embodiments of the present disclosure, an electronic paper display device includes a thin film transistor (TFT) array substrate, a light-transmitting substrate, a top electrode layer, a display medium layer, and a sealant. A top surface of the TFT array substrate has a bottom electrode layer. The light-transmitting substrate is located above the TFT array substrate. The top electrode layer is located on a bottom surface of the light-transmitting substrate. The display medium layer is located between the top electrode layer and the bottom electrode layer, wherein an edge of the display medium layer is recessed from a sidewall of the light-transmitting substrate so that the light-transmitting substrate has a protruding portion. The sealant is located between the protruding portion of the light-transmitting substrate and the TFT array substrate, surrounds the display medium layer, and extends to a lower portion of the sidewall of the light-transmitting substrate.

In some embodiments, the electronic paper display device further includes a barrier layer directly formed on a top surface of the light-transmitting substrate.

In some embodiments, the electronic paper display device further includes a barrier layer directly formed on the bottom surface of the light-transmitting substrate, wherein the top electrode layer is directly formed on a bottom surface of the barrier layer, such that the top electrode layer is in direct contact with the barrier layer.

One aspect of the present disclosure provides a manufacturing method of an electronic paper display device.

According to some embodiments of the present disclosure, a manufacturing method of an electronic paper display device includes directly forming a barrier layer on at least one of a top surface and a bottom surface of a light-transmitting substrate, wherein the barrier layer is in direct contact with the light-transmitting substrate, and is configured to resist moisture; forming a top electrode layer on the bottom surface of the light-transmitting substrate; forming a display medium layer on the top electrode layer on the light-transmitting substrate; and disposing the light-transmitting substrate and the display medium layer on a thin film transistor (TFT) array substrate, such that the display medium layer is located between the top electrode layer and a bottom electrode layer of the TFT array substrate.

In some embodiments, the top electrode layer is directly formed on the bottom surface of the light-transmitting substrate.

In some embodiments, the barrier layer is directly formed on the bottom surface of the light-transmitting substrate, and the top electrode layer is directly formed on a bottom surface of the barrier layer, such that the top electrode layer is in direct contact with the barrier layer.

In the aforementioned embodiments of the present disclosure, since the top electrode layer of the electronic paper display device is located on the bottom surface of the light-transmitting substrate, and the barrier layer is directly formed on at least one of the top surface and the bottom surface of the light-transmitting substrate, the light-transmitting substrate on which the top electrode layer and the barrier layer are disposed has the functions of conducting electricity and blocking water vapor, and can replace an upper substrate of a front panel laminate (FPL) and an overlying anti-moisture protective sheet of a traditional electronic paper display device, and can further omit an optical clear adhesive (OCA) used to attach the upper substrate and the protective sheet. As a result, the electronic paper display device of the present disclosure can effectively reduce the number of stack layers. Compared with the traditional electronic paper display device, the electronic paper display device of the present disclosure can reduce the height of the water blocking zone between the top surface of the TFT array substrate and the barrier layer by 20%, and thus the expected amount of moisture intrusion is reduced by 20% to improve the reliability of the electronic paper display device. In addition, such a configuration can reduce the overall thickness and material cost of the electronic paper display device, and can improve optical transmittance, which are beneficial to user experience and product competitiveness.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a cross-sectional view of an electronic paper display device according to one embodiment of the present disclosure.

FIG. 2 is a schematic view of the electronic paper display device of FIG. 1 when being in use.

FIG. 3 is a cross-sectional view of an electronic paper display device according to another embodiment of the present disclosure.

FIG. 4 is a cross-sectional view of an electronic paper display device according to still another embodiment of the present disclosure.

FIG. 5 is a flow chart of a manufacturing method of an electronic paper display device according to one embodiment of the present disclosure.

FIG. 6 is a cross-sectional view of an electronic paper display device according to yet another embodiment of the present disclosure.

FIG. 7 shows a display medium layer according to another embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

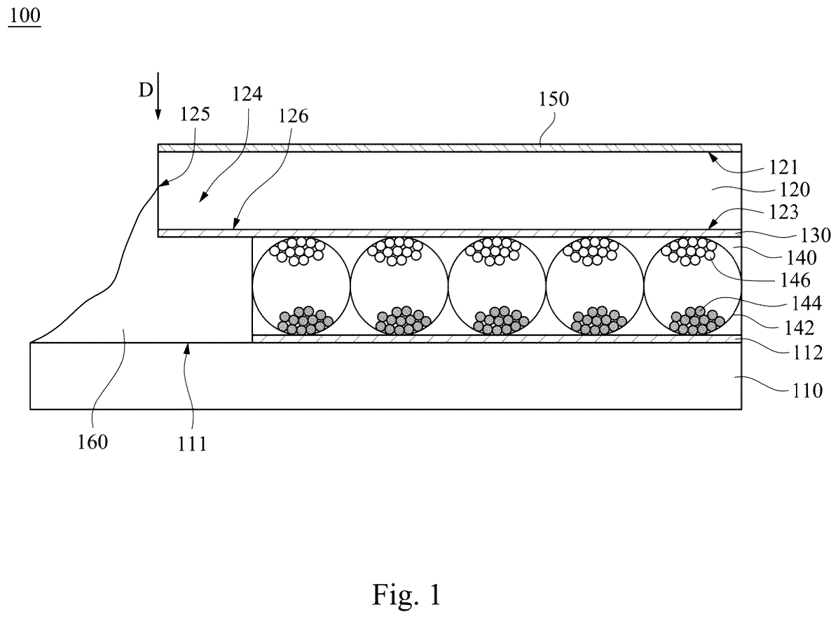

FIG. 1 is a cross-sectional view of an electronic paper display device 100 according to one embodiment of the present disclosure. As shown in FIG. 1, the electronic paper display device 100 includes a thin film transistor (TFT) array substrate 110, a light-transmitting substrate 120, a top electrode layer 130, a display medium layer 140, and a barrier layer 150. A top surface 111 of the TFT array substrate 110 has a bottom electrode layer 112. The top electrode layer 130 is a common electrode, and the bottom electrode layer 112 is a pixel electrode. The light-transmitting substrate 120 is located above the TFT array substrate 110. The top electrode layer 130 is located on a bottom surface 123 of the light-transmitting substrate 120. The display medium layer 140 is located between the top electrode layer 130 and the bottom electrode layer 112. The barrier layer 150 is directly formed on at least one of a top surface 121 and the bottom surface 123 of the light-transmitting substrate 120. In the specifications, “directly formed” is referred to as forming another layer along the surface of one layer so that the two layers are in contact with each other. The light-transmitting substrate 120 can be specially treated (such as plasma bombardment) so as to have sufficient bonding strength between it and the top electrode layer 130, and thus the barrier layer 150 and the top electrode layer 130 can be integrated on the same film material. The barrier layer 150 and the top electrode layer 130 may be formed by chemical vapor deposition (CVD) and physical vapor deposition (PVD), but the present disclosure is not limited in this regard. In this embodiment, the barrier layer 150 is directly formed on the top surface 121 of the light-transmitting substrate 120. Moreover, the barrier layer 150 is in direct contact with the light-transmitting substrate 120, and can be used to resist moisture (water vapor).

In some embodiments, the material of the barrier layer 150 may be, but not limited to silicon oxide (SiO₂). The top electrode layer 130 and the bottom electrode layer 112 are transparent electrodes, and the material of them is such as indium tin oxide (ITO), but not limited thereto. The TFT array substrate 110 and the light-transmitting substrate 120 both are flexible, and are bendable flexible substrates. The material of the TFT array substrate 110 and the light-transmitting substrate 120 may be, but not limited to polyethylene terephthalate (PET). For example, polyimide (PI) may also be used as the material of the flexible substrates. The front panel laminate (FPL) of the electronic paper display device 100 may include the light-transmitting substrate 120, the top electrode layer 130, and the display medium layer 140. The top surface 111 of the TFT array substrate 110 has a TFT array electrically connected to the bottom electrode layer 112. Moreover, the display medium layer 140 may be an electronic ink (i.e., electrophoretic ink; E-ink) layer including plural microcapsules 142, and each of the microcapsules 142 has charged particles 144 and 146 with different colors. For example, the charged particles 144 are black particles, and the charged particles 146 are white particles, but the present disclosure is not limited to this regard. The top electrode layer 130 and the bottom electrode layer 112 can apply a voltage to the display medium layer 140, such that the display medium layer 140 shows bright and dark changes. For example, the charged particles 146 are driven to upper positions to present a white color, or the charged particles 144 are driven to upper positions to present a black color. In another embodiment, the charged particles 144 and 146 may be other colors.

Specifically, since the top electrode layer 130 of the electronic paper display device 100 is located on the bottom surface 123 of the light-transmitting substrate 120, and the barrier layer 150 is directly formed on the top surface 121 of the light-transmitting substrate 120, the light-transmitting substrate 120 on which the top electrode layer 130 and the barrier layer 150 are disposed has the functions of conducting electricity and blocking water vapor (moisture), and can replace an upper substrate of a front panel laminate (FPL) and an overlying anti-moisture protective sheet (a substrate having a moisture barrier layer) of a traditional electronic paper display device, and can further omit an optical clear adhesive (OCA) used to attach the upper substrate and the protective sheet.

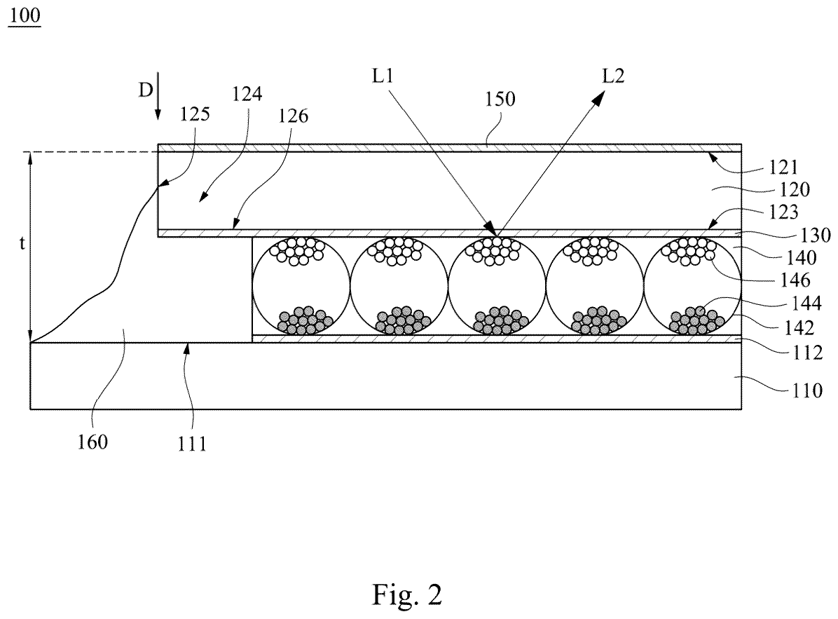

FIG. 2 is a schematic view of the electronic paper display device 100 of FIG. 1 when being in use. The electronic paper display device 100 can effectively reduce the number of stack layers, and merely has three layers of main structures, that is, the TFT array substrate 110, the display medium layer 140, and a single light-transmitting substrate 120. Such a design can reduce the height t of the water blocking zone between the top surface 111 of the TFT array substrate 110 and the barrier layer 150 by 20% compared with a traditional electronic paper display device. Based on the theory of water vapor penetration, the expected amount of moisture intrusion of the electronic paper display device 100 can be reduced by 20% to improve the reliability of the electronic paper display device 100.

In addition, the electronic paper display device 100 can reduce the overall thickness and the material cost, which is beneficial to product competitiveness. Since a substrate having a moisture barrier layer and an optical clear adhesive used in a traditional electronic paper display device are removed, when the electronic paper display device 100 receives incident light L1 (e.g., sunlight), the incident light L1 can be reflected by the display medium layer 140 only after passing through the barrier layer 150, the light-transmitting substrate 120, and the top electrode layer 130 in sequence. Moreover, reflected light L2 only passes through the top electrode layer 130, the light-transmitting substrate 120, and the barrier layer 150 in sequence so as to be viewed by human eyes, which can effectively improve optical transmittance and is beneficial to the user experience.

In this embodiment, the barrier layer 150 is directly formed on the top surface 121 of the light-transmitting substrate 120, and the top electrode layer 130 is directly formed on the bottom surface 123 of the light-transmitting substrate 120. The light-transmitting substrate 120 is located between the barrier layer 150 and the top electrode layer 130. The top surface of the barrier layer 150 is exposed. The light-transmitting substrate 120 has a sidewall 125 adjacent to the top surface 121 and the bottom surface 123, and the sidewall 125 of the light-transmitting substrate 120, the edge of the barrier layer 150, and the edge of the top electrode layer 130 are aligned with each other in a vertical direction D.

Furthermore, the edge of the display medium layer 140 is recessed from the sidewall 125 of the light-transmitting substrate 120 so that the light-transmitting substrate 120 has a protruding portion 124. In other words, the size of the display medium layer 140 (e.g., length or width) along a horizontal direction is less than the size of the light-transmitting substrate 120 along the horizontal direction (e.g., length or width). As a result, the bottom surface 123 of the light-transmitting substrate 120 has a functional area 126 extending outward from the display medium layer 140, and the top electrode layer 130 may extend to the functional area 126. The functional area 126 caused by the different sizes between the light-transmitting substrate 120 and the display medium layer 140 may serve as a water blocking zone or a conductive area. For example, the functional area 126 may be used for being filled with waterproof glue to have water-blocking function, or filled with conductive glue to have the function of conducting electricity.

In this embodiment, the electronic paper display device 100 may further include a sealant 160. The sealant 160 is located between the protruding portion 124 of the light-transmitting substrate 120 and the TFT array substrate 110, and the sealant 160 surrounds the display medium layer 140. The sealant 160 may be glue material for blocking moisture, such as water-blocking glue. The sealant 160 may be in contact with the bottom surface and the edge of the top electrode layer 130 for protection. The sealant 160 can extend to the lower portion of the sidewall 125 of the light-transmitting substrate 120, such that the upper portion of the sidewall 125 of the light-transmitting substrate 120 is exposed. In other embodiments, the sealant 160 may cover the entire sidewall 125 of the light-transmitting substrate 120 as deemed necessary by design.

It is to be noted that the connection relationships, the materials, and the advantages of the elements described above will not be repeated in the following description. In the following description, other types of electronic paper display devices will be explained.

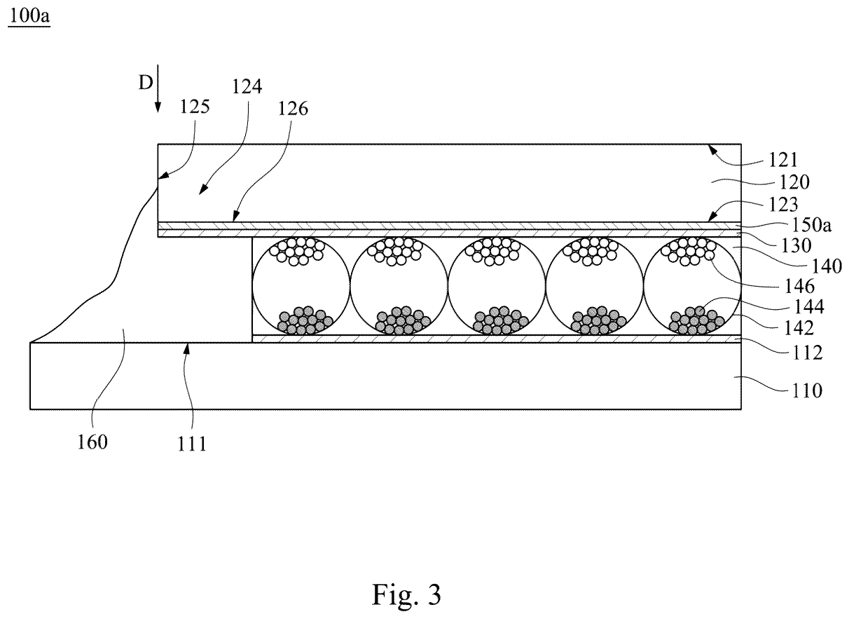

FIG. 3 is a cross-sectional view of an electronic paper display device 100a according to another embodiment of the present disclosure. The electronic paper display device 100a includes the thin film transistor (TFT) array substrate 110, the light-transmitting substrate 120, the top electrode layer 130, the display medium layer 140, a barrier layer 150a, and the sealant 160. The differences between this embodiment and the embodiment of FIG. 1 are that the barrier layer 150a is directly formed on the bottom surface 123 of the light-transmitting substrate 120, and the top surface 121 of the light-transmitting substrate 120 is exposed. Moreover, the top electrode layer 130 of the electronic paper display device 100a is directly formed on the bottom surface of the barrier layer 150a, such that the top electrode layer 130 is in direct contact with the barrier layer 150a. The top electrode layer 130 is located between the barrier layer 150a and the display medium layer 140.

In this embodiment, the bottom surface 123 of the light-transmitting substrate 120 has the functional area 126 extending outward from the display medium layer 140, and the barrier layer 150a and the top electrode layer 130 extend to the functional area 126. In some embodiments, the functional area 126 may be filled with waterproof glue to form a water blocking zone, or filled with conductive glue to form an area having the function of conducting electricity. In addition, the sealant 160 may be in contact with and cover the bottom surface and the edge of the top electrode layer 130 and the edge of the barrier layer 150a for protection.

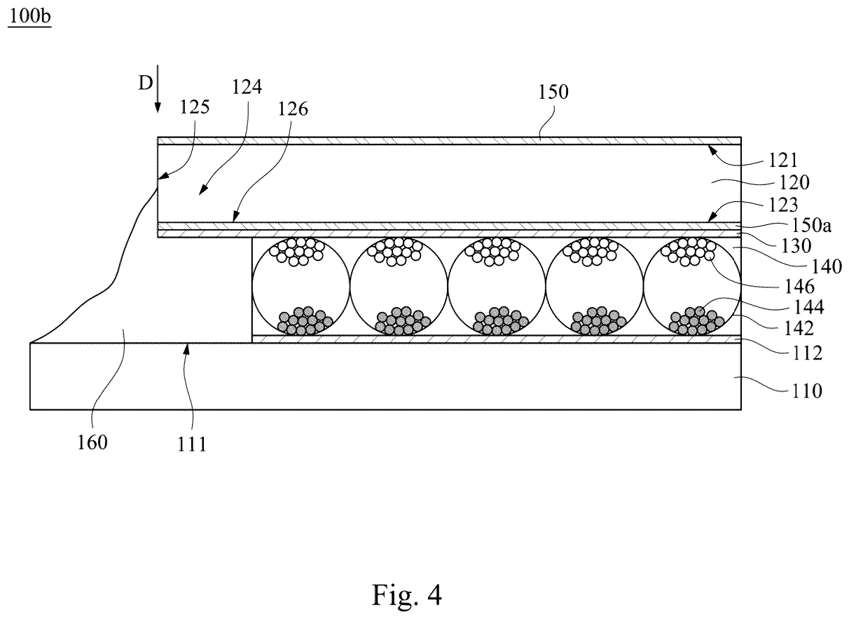

FIG. 4 is a cross-sectional view of an electronic paper display device 100b according to still another embodiment of the present disclosure. The electronic paper display device 100b includes the thin film transistor (TFT) array substrate 110, the light-transmitting substrate 120, the top electrode layer 130, the display medium layer 140, the barrier layers 150 and 150a, and the sealant 160. The differences between this embodiment and the embodiments of FIGS. 1 and 3 are that the electronic paper display device 100b has the barrier layers 150 and 150a that are directly formed on the top surface 121 and the bottom surface 123 of the light-transmitting substrate 120, respectively. The barrier layer 150a is directly formed on the bottom surface 123 of the light-transmitting substrate 120, and the top electrode layer 130 is directly formed on the bottom surface of the barrier layer 150a, such that the top electrode layer 130 is in direct contact with the barrier layer 150a. The barrier layers 150 and 150a located on the top surface 121 and the bottom surface 123 of the light-transmitting substrate 120 can allow the electronic paper display device 100b to have a better moisture-resistant capability. Since the electronic paper display device 100b has the two barrier layers 150 and 150a, lower-cost materials for the barrier layer can be used to achieve moisture-resistant effect similar to that of the electronic paper display devices 100 and 100a.

It is to be noted that the connection relationships, the materials, and the advantages of the elements described above will not be repeated in the following description. In the following description, the manufacturing method of the aforementioned electronic paper display device will be explained.

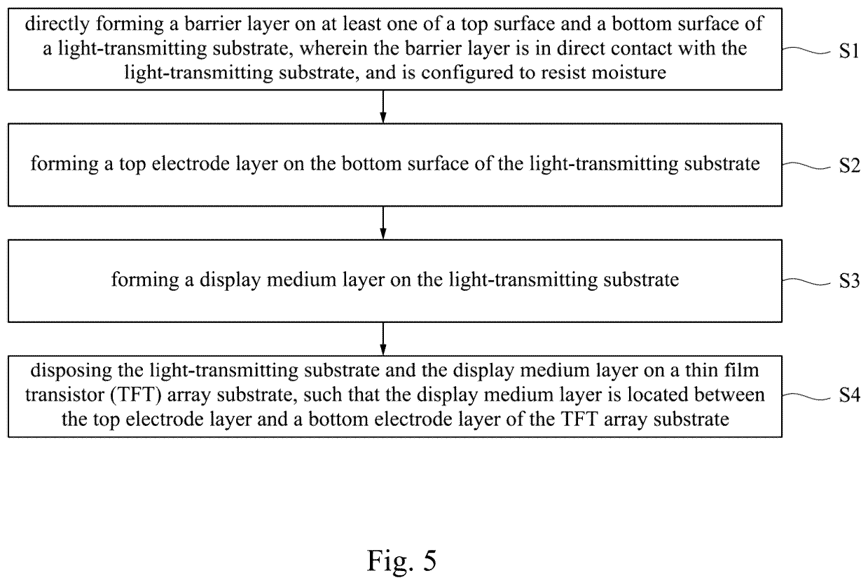

FIG. 5 is a flow chart of a manufacturing method of an electronic paper display device according to one embodiment of the present disclosure. In step S1, as shown in FIGS. 1, 3, and 4, the barrier layer 150 or 150a may be directly formed on at least one of the top surface 121 and the bottom surface 123 of the light-transmitting substrate 120, such as the barrier layer 150 of FIG. 1 formed on the top surface 121 of the light-transmitting substrate 120; the barrier layer 150a of FIG. 3 formed on the bottom surface 123 of the light-transmitting substrate 120; and the barrier layers 150 and 150a of FIG. 4 respectively formed on the top surface 121 and the bottom surface 123 of the light-transmitting substrate 120. Thereafter, in step S2, the top electrode layer 130 may be formed on the bottom surface 123 of the light-transmitting substrate 120. In the embodiments of FIGS. 3 and 4, the barrier layer 150a is formed on the bottom surface 123 of the light-transmitting substrate 120, and then the top electrode layer 130 is formed on the barrier layer 150a such that the barrier layer 150a is located between the top electrode layer 130 and the bottom surface 123 of the light-transmitting substrate 120.

In step S3, the display medium layer 140 may be formed on the light-transmitting substrate 120, such as by coating. As a result, the light-transmitting substrate 120 and the display medium layer 140 may be regarded as the same film material. Steps S1 to S3 can be performed by roll-to-roll manufacturing process. Thereafter, in step S4, the light-transmitting substrate 120 and the display medium layer 140 may be disposed on the thin film transistor (TFT) array substrate 110, such that the display medium layer 140 is located between the light-transmitting substrate 120 and the TFT array substrate 110, and between the top electrode layer 130 and the bottom electrode layer 112 of the TFT array substrate 110.

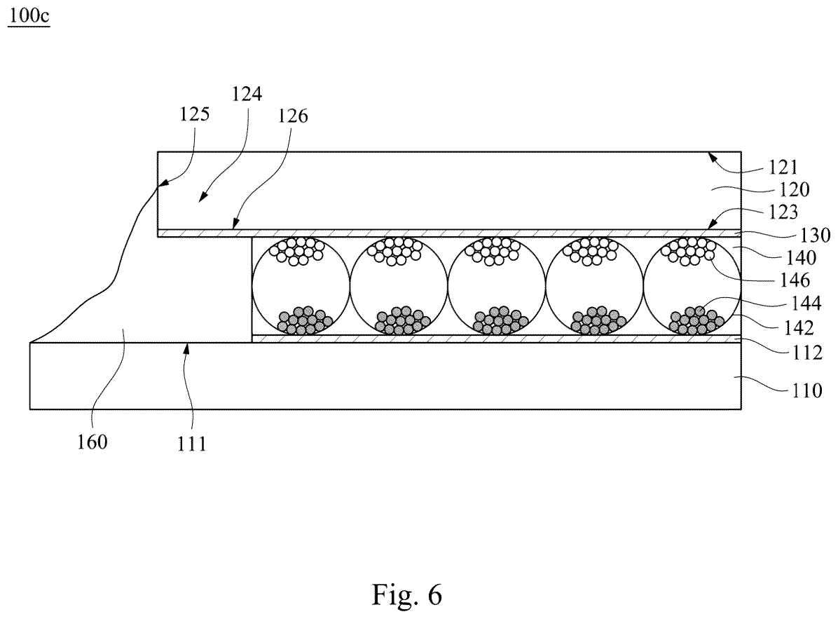

FIG. 6 is a cross-sectional view of an electronic paper display device 100c according to yet another embodiment of the present disclosure. The electronic paper display device 100c includes the thin film transistor (TFT) array substrate 110, the light-transmitting substrate 120 that has the function of blocking water vapor, the top electrode layer 130, the display medium layer 140, and the sealant 160. The edge of the display medium layer 140 is recessed from the sidewall 125 of the light-transmitting substrate 120 so that the light-transmitting substrate 120 has the protruding portion 124. The sealant 160 is located between the protruding portion 124 of the light-transmitting substrate 120 and the TFT array substrate 110, and the sealant 160 surrounds the display medium layer 140. The difference between this embodiment and the embodiment of FIG. 1 is that the electronic paper display device 100c has no barrier layer 150 of FIG. 1. Since the material of the light-transmitting substrate 120 of the electronic paper display device 100c itself has the capability to block water and vapor, additional aforementioned barrier layers 150 and 150a are unneeded. In other words, the electronic paper display device 100a of FIG. 3 may omit the barrier layer 150a, while the electronic paper display device 100b of FIG. 4 may omit at least one of the barrier layers 150 and 150a.

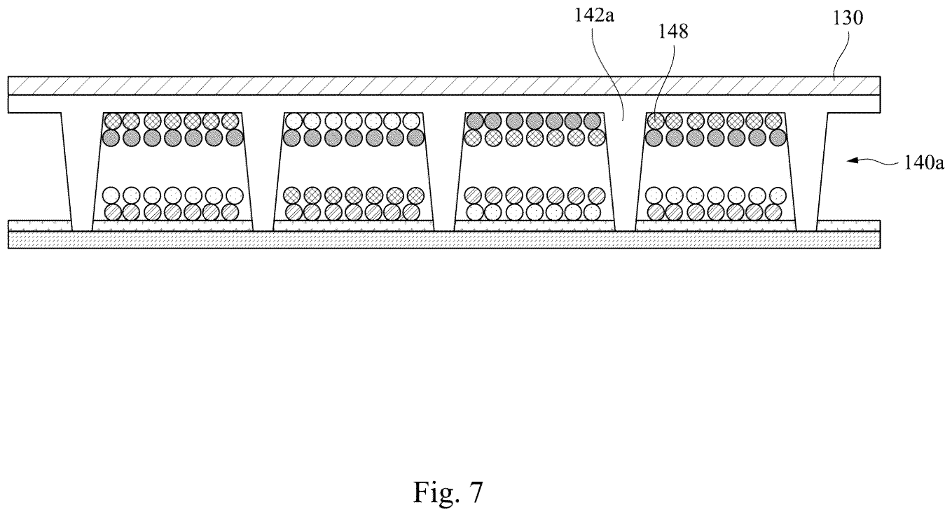

In the embodiments of FIGS. 1, 3, and 4, the display medium layer 140 is a microcapsule type. FIG. 7 shows a display medium layer 140a according to another embodiment of the present disclosure. The display medium layer 140a is a microcup type. The display medium layer 140a includes plural microcups 142a, and each of the microcups 142a may include charged particles 148 with different colors (e.g., yellow, green, white, and red). In some embodiments, the display medium layer 140a having the microcups 142a of FIG. 7 may replace the display medium layer 140 having the microcapsules 142 of FIGS. 1, 3, and 4.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An electronic paper display device, comprising:
a thin film transistor (TFT) array substrate, wherein a top surface of the TFT array substrate has a bottom electrode layer;
a light-transmitting substrate located above the TFT array substrate;
a top electrode layer located on a bottom surface of the light-transmitting substrate;
a display medium layer located between the top electrode layer and the bottom electrode layer; and
a barrier layer directly formed on at least one of a top surface and the bottom surface of the light-transmitting substrate, wherein the barrier layer is in direct contact with the light-transmitting substrate, and is configured to resist moisture.

2. The electronic paper display device of claim 1, wherein the barrier layer is directly formed on the top surface of the light-transmitting substrate, and the top electrode layer is directly formed on the bottom surface of the light-transmitting substrate.

3. The electronic paper display device of claim 2, wherein the bottom surface of the light-transmitting substrate has a functional area extending outward from the display medium layer, and the top electrode layer extends to the functional area.

4. The electronic paper display device of claim 2, wherein a top surface of the barrier layer is exposed.

5. The electronic paper display device of claim 1, wherein the barrier layer is directly formed on the bottom surface of the light-transmitting substrate, and the top electrode layer is directly formed on a bottom surface of the barrier layer, such that the top electrode layer is in direct contact with the barrier layer.

6. The electronic paper display device of claim 5, wherein the bottom surface of the light-transmitting substrate has a functional area extending outward from the display medium layer, and the barrier layer and the top electrode layer extend to the functional area.

7. The electronic paper display device of claim 5, wherein the top surface of the light-transmitting substrate is exposed.

8. The electronic paper display device of claim 1, wherein a sidewall of the light-transmitting substrate, an edge of the barrier layer, and an edge of the top electrode layer are aligned with each other in a vertical direction.

9. The electronic paper display device of claim 1, wherein an edge of the display medium layer is recessed from a sidewall of the light-transmitting substrate so that the light-transmitting substrate has a protruding portion, and the electronic paper display device further comprises a sealant located between the protruding portion of the light-transmitting substrate and the TFT array substrate, and the sealant surrounds the display medium layer.

10. The electronic paper display device of claim 9, wherein the sealant is in contact with a bottom surface of the top electrode layer.

11. The electronic paper display device of claim 10, wherein the sealant extends to a lower portion of the sidewall of the light-transmitting substrate, such that an upper portion of the sidewall of the light-transmitting substrate is exposed.

12. The electronic paper display device of claim 1, wherein the display medium layer comprises a plurality of microcapsules or a plurality of microcups, and each of the microcapsules or each of the microcups has charged particles with different colors.

13. An electronic paper display device, comprising:
a thin film transistor (TFT) array substrate, wherein a top surface of the TFT array substrate has a bottom electrode layer;
a light-transmitting substrate located above the TFT array substrate;
a top electrode layer located on a bottom surface of the light-transmitting substrate;
a display medium layer located between the top electrode layer and the bottom electrode layer, wherein an edge of the display medium layer is recessed from a sidewall of the light-transmitting substrate so that the light-transmitting substrate has a protruding portion; and
a sealant located between the protruding portion of the light-transmitting substrate and the TFT array substrate, surrounding the display medium layer, and extending to a lower portion of the sidewall of the light-transmitting substrate.

14. The electronic paper display device of claim 13, further comprising:
a barrier layer directly formed on a top surface of the light-transmitting substrate.

15. The electronic paper display device of claim 13, further comprising:
a barrier layer directly formed on the bottom surface of the light-transmitting substrate, wherein the top electrode layer is directly formed on a bottom surface of the barrier layer, such that the top electrode layer is in direct contact with the barrier layer.

16. A manufacturing method of an electronic paper display device, comprising:
directly forming a barrier layer on at least one of a top surface and a bottom surface of a light-transmitting substrate, wherein the barrier layer is in direct contact with the light-transmitting substrate, and is configured to resist moisture;
forming a top electrode layer on the bottom surface of the light-transmitting substrate;
forming a display medium layer on the top electrode layer on the light-transmitting substrate; and
disposing the light-transmitting substrate and the display medium layer on a thin film transistor (TFT) array substrate, such that the display medium layer is located between the top electrode layer and a bottom electrode layer of the TFT array substrate.

17. The manufacturing method of the electronic paper display device of claim 16, wherein the top electrode layer is directly formed on the bottom surface of the light-transmitting substrate.

18. The manufacturing method of the electronic paper display device of claim 16, wherein the barrier layer is directly formed on the bottom surface of the light-transmitting substrate, and the top electrode layer is directly formed on a bottom surface of the barrier layer, such that the top electrode layer is in direct contact with the barrier layer.
